(19) United States
(12) Patent Application Publication
(10) Pub. No.: US 2014/0119639 A1
(43) Pub. Date: May 1, 2014

(54) WATER-BODY CLASSIFICATION

(71) Applicant: MICROSOFT CORPORATION, Redmond, WA (US)

(72) Inventors: Chintan Anil Shah, Boulder, CO (US); Anthony John Thorpe, Superior, CO (US); Wolfgang Schickler, Boulder, CO (US)

(73) Assignee: Microsoft Corporation, Redmond, WA (US)

(21) Appl. No.: 13/665,068

(22) Filed: Oct. 31, 2012

(51) Int. Cl. G06K 9/62; G06K 9/00

(52) U.S. Cl. 382/154

(57) ABSTRACT

Among other things, one or more techniques and/or systems are provided for classifying a water-body. For example, initial water-body segmentation may be used to segment imagery into water-body features or non-water-body features to create an initial water-body map. The initial water-body map may be refined based upon confidence scores assigned to pixels within the imagery. In one example, a confidence score may correspond to a confidence that a stereo matching technique produced a correct elevation for a pixel. A relatively low confidence score may indicate that the pixel corresponds to water (e.g., due to a lack of features/texture on water), while a relatively high confidence score may indicate that the pixel does not correspond to water (e.g., due to presence of features/texture, such as roads, building corners, etc.). In this way, confidence scores may, for example, be used to refine the initial water-body map to create a final water-body map.

### BACKGROUND

Many users may discover and interact with content through mapping user interfaces, such as a mapping website or a mapping application. In one example, a user may utilize an interactive mapping application on a mobile device to identify driving directions to a particular location. In another example, a user may plan a vacation by discovering interesting locations identified by a mapping website. In another example, an engineering company may utilize a geological mapping application to identify areas of a lake that are to be examined for research. Many of the maps provided by mapping user interfaces are constructed from imagery data and/or GPS data. Unfortunately, distinguishing amongst various types of materials, such as concrete, vegetation, soil, and/or water, within the imagery data may be difficult. In one example, a water-body with relatively high levels of algae may be incorrectly classified as vegetation by a spectral analysis technique. In another example, a shadowy rooftop may be incorrectly classified as a water-body by the spectral analysis technique.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for classifying a water-body are provided herein. That is, imagery may be processed using one or more confidence scores (e.g., a confidence map comprising one or more confidence scores derived from stereo-matching of aerial imagery) to create a final water-body map that defines a spatial extent of a water-body depicted by the imagery. It may be appreciated that imagery may comprise different types of imagery, such as multispectral imagery (e.g., imagery comprising multiple bands, such as red, green, blue, infrared, etc.), panchromatic imagery, areal imagery, terrestrial imagery, street-side imagery, and/or other image types.

In one example of classifying a water-body, initial water-body segmentation may be performed upon imagery to create an initial water-body map. For example, a normalized difference water index (NDWI) image may be derived from the imagery. The NDWI image may be based upon a normalized difference between blue and near-infrared (NIR) spectral bands because water may have a relatively high response (e.g., reflectance) in the blue wavelength, but a relatively low response in the NIR wavelength. The NDWI image may be segmented into water-body features and non-water-body features to create the initial water-body map (e.g., based up a histogram of the NDWI image). In one example of initial water-body segmentation, a global segmentation may be performed upon pixels of the NDWI image to identify water-body features. In another example of initial water-body segmentation, one or more localized segmentations may be performed upon regions of the NDWI image to identify water-body features. In this way, the initial water-body map, identifying one or more water-body features, may be created.

Various image processing techniques, such as shadow removal and/or elevation feature removal may be used to refine the initial water-body map. In one example, a digital surface model may be used to identify spatial extents of shadow features within the remotely sense imagery to create a shadow mask image. The shadow mask image may be used to remove one or more portions of the initial water-body map that intersect shadow features within the shadow mask image, which may mitigate erroneous classification of shadows as water. In another example, the digital surface model may be used to identify elevation features with elevations above a ground feature threshold to create an elevation mask image. The elevation mask image may be used to remove one or more portions of the initial water-body map that intersect elevation features within the elevation mask image (e.g., elevation features corresponding to building roof tops), which may mitigate erroneous classification of non-water features as water.

A confidence map may, for example, comprise one or more confidence scores derived from stereo-matching of points between two or more images. For example, a confidence score may comprise a first confidence that a point within a first image of imagery corresponds to the (same) point within a second image of the imagery (e.g., a confidence that a projection of the point within the first image at a first location corresponds to a projection of the point within the second image at a second location). A stereographical mapping technique may, for example, be used to project a point within a first remotely sensed image to a first location, and to project the point within a second remotely sensed image to a second location. The first location and the second location may be triangulated to determine whether the point at the first location corresponds to the point at the second location (e.g., to estimate an elevation for the point). A confidence score may be assigned to the point based upon a confidence that the point at the first location corresponds to the point at the second location (e.g., based upon a matching score between one or more features, such as textures, for example, of the first location and one or more features of the second location). In an example, the confidence score may correspond to a confidence that a confidence model (e.g., a confidence model associated with a stereo matching technique) produced a correct elevation for the point between the two or more images. A relatively low confidence score may indicate that the point corresponds to water, while a relatively high confidence score may indicate that the point does not correspond to water because elevation may be difficult to estimate for water due to various features of water (e.g., water movement, white caps, non-uniform texture, etc.). Thus, a relatively low confidence score indicative of a (low) confidence that a point within a first image corresponds to the (same) point in a second image may be indicative of water because movement of water (e.g., waves, white caps, etc.) may likely make the same point appear differently (e.g., at two different elevations) between the first image and the second image. Accordingly, confidence scores may be created for one or more points, such as pixels, within the imagery. In this way, the initial water-body map may be refined to create a final water-body map. For example, a spatial extent of a water-body within the initial water-body map may be refined to comprise pixels with relatively low confidence scores, but not pixels with relatively high confidence scores.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of classifying a water-body.

FIG. 2 is a component block diagram illustrating an exemplary system for classifying a water-body.

FIG. 3 is an illustration of an example of imagery.

FIG. 4 is an illustration of an example of creating an initial water-body map.

FIG. 5 is an illustration of an example of a shadow image mask, an elevation image mask, and/or confidence scores.

FIG. 6 is an illustration of an example of creating a final water-body map.

FIG. 7 is an illustration of an exemplary computer-readable medium wherein processor-executable instructions configured to embody one or more of the provisions set forth herein may be comprised.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

Various sources of data, such as satellite imagery, aerial photography, GPS data, and/or other information may be used to create maps. Because many of the maps are digitally constructed, it may be advantageous to classify various features within the maps, such as water-bodies. Unfortunately, many techniques for classifying water-bodies within a map do not provide accurate details for certain map applications (e.g., a developer of real estate along a shoreline may need a highly accurate depiction of the shoreline for proper development planning). Accordingly, as provided herein, a final water-body map may be created based upon classifying a water-body using one or more confidence scores associated with imagery (e.g., a confidence that a point in a first image matches the (same) point in a second image). The final water-body map may be used by a mapping user interface to define the water-body within a map.

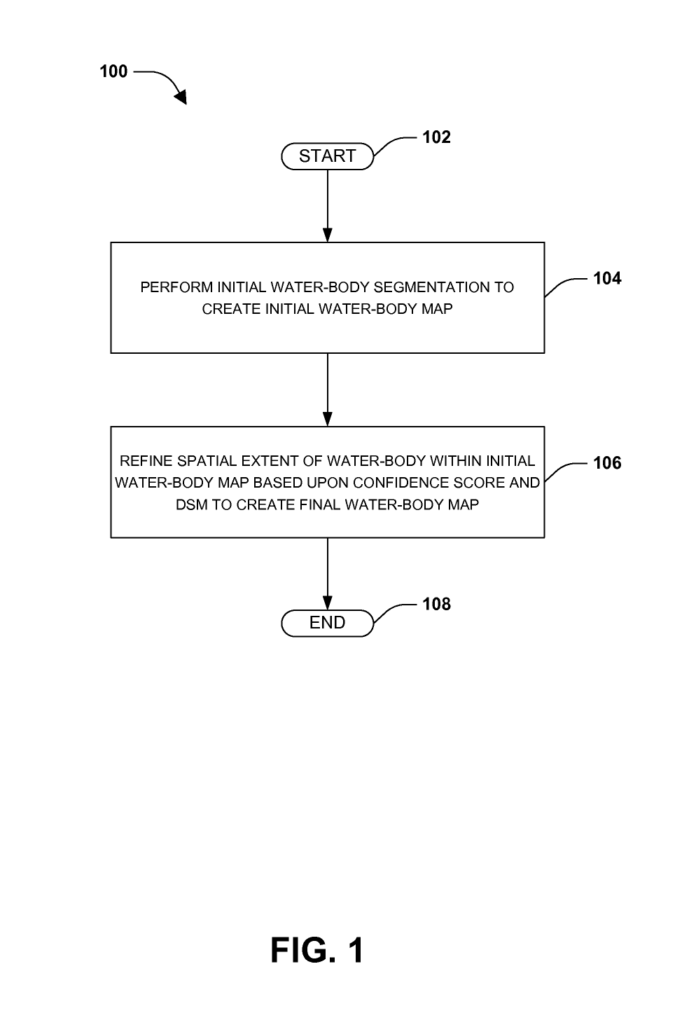

One embodiment of classifying a water-body is illustrated by an exemplary method 100 in FIG. 1. At 102, the method starts. At 104, initial water-body segmentation may be performed upon imagery (e.g., multispectral imagery, panchromatic imagery, a photo, imagery from a hand-held camera (e.g., to acquire land-scape images), imagery from a terrestrial camera (e.g., to acquire street-side images), imagery from a camera that may or may not have near-infrared spectral band, etc.) to create an initial water-body map. Various types of initial water-body segmentation may be performed. In one example of initial water-body segmentation, global segmentation of water-body features from non-water-body features may be performed upon a normalized difference water index (NDWI) image derived from the imagery. The NDWI image may be based upon a normalized difference between blue and near-infrared (NIR) spectral bands because water may have a relatively high response (e.g., reflectance) in the blue wavelength, but a relatively low response in the NIR wavelength. The global segmentation may compare respective pixels of the NDWI image (e.g., normalized difference values of such pixels) against a global threshold to segment water-body features from non-water-body features. For example, where normalized difference values range from −1 to 1 (e.g., within a histogram derived from the NDWI image), the global threshold may be set to 0.4, such that pixels with normalized difference values above 0.4 may be identified as water-body features.

In another example of initial water-body segmentation, one or more localized segmentations of water-body features from non-water-body features may be performed upon the NDWI image. For example, localized segmentation may be performed upon a region of the NDWI image (e.g., pixels identified, for example by global segmentation, as corresponding to water-body features and/or neighboring pixels within a threshold distance from the water-body features). In this way, a particular water-body may be refined based upon localized segmentation (e.g., pixels, located within a threshold distance of a water-body, with normalized difference values above 0.39 may be segmented as part of the water-body).

In another example of initial water-body segmentation, a digital surface model may be used to identify spatial extent of shadow features within the imagery to create a shadow mask image. One or more portions of the initial water-body map that intersect shadow features within the shadow mask image may be removed, which may mitigate incorrect classification of shadows as water. In another example of initial water-body segmentation, the digital surface model may be used to identify elevation features with elevations above a ground feature threshold (e.g., a threshold elevation at which water may not be present within the imagery, such as elevations of trees, buildings, etc.) to create an elevation mask image. One or more portions of the initial water-body map that intersect elevation features within the elevation mask image may be removed, which may mitigate incorrect classification of particular structures, such as roof-tops, as water.

A confidence model may be used to match points between two or more images (e.g., at least partially overlapping images) within the imagery. For example, a stereographical mapping technique may be used to project a point within a first remotely sensed image to a first location, and to project the point within a second remotely sensed image to a second location. The first location and the second location may be triangulated to match the point between the first image and the second image (e.g., to estimate an elevation of the point). A confidence score, for example, may be assigned to the point based upon a matching score or degree of matching, for example, between one or more features of the first location and one or more features of the second location. Because water may be associated with undesirable features (e.g., non-uniform texture between the first and second remotely sensed image due to water movement, algae, white caps, waves, etc.) for estimating elevation, a relatively low confidence score for a first pixel may indicate that the first pixel corresponds to water, while a relatively high confidence score for a second pixel may indicate that the second pixel is not water. In this way, a pixel within the initial water-body map may be determined as corresponding to water based upon the pixel being assigned a confidence score below a threshold, otherwise, the pixel may be determined as not corresponding to water.

At 106, a spatial extent of a water-body within the initial water-body map may be refined based upon one or more confidence scores (e.g., a confidence map derived from stereo-matching of two or more (at least partially) overlapping aerial images) to create a final water-body map. In one example, the spatial extent of the water-body may be extended to comprise one or more neighboring pixels having confidence scores below a threshold. In another example, the spatial extent of the water-body may be refined to not comprise one or more pixels having confidence scores above the threshold. In an example, the initial water-body map may be refined based upon a digital surface model (DSM), for example, to address one or more shadow and/or one or more elevation related issues, for example. In this way, a final water-body map may be created. The final water-body map may be used by a mapping user interface to define the water-body within a map. At 110, the method ends.

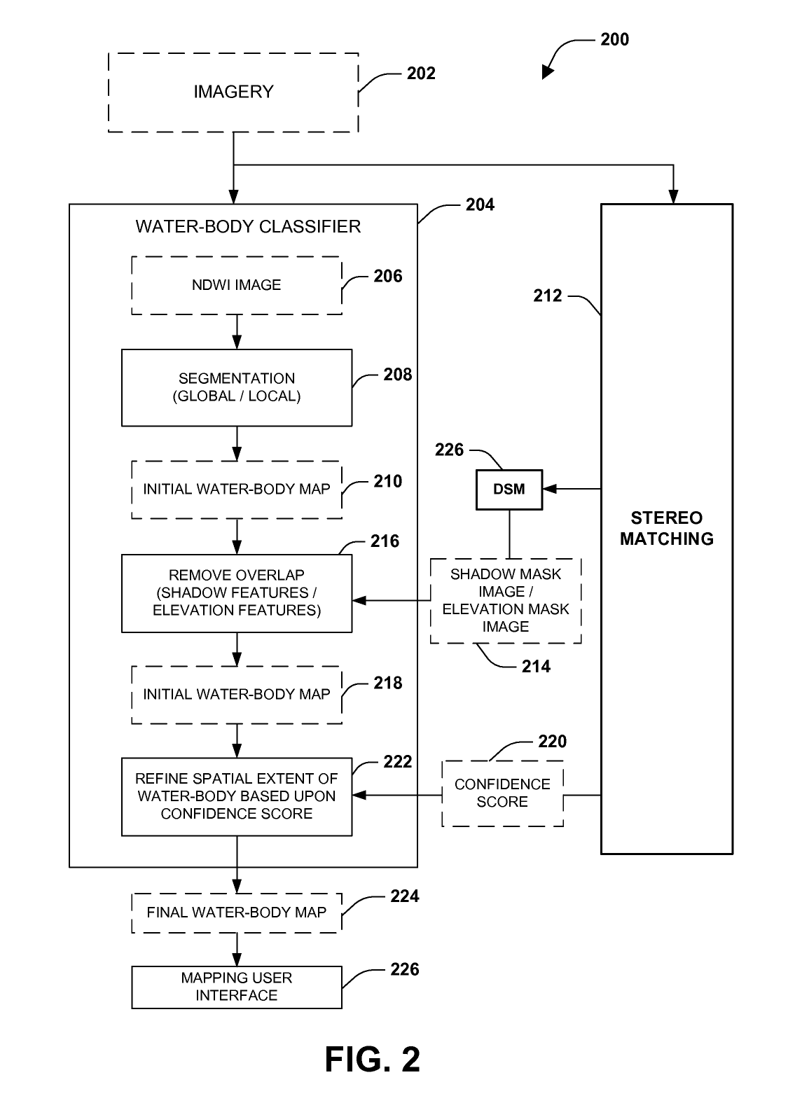

FIG. 2 illustrates an example of a system 200 configured for classifying a water-body. The system 200 may comprise a water-body classifier 204. The water-body classifier 204 may be configured to perform initial water-body segmentation 208 upon imagery 202 to create an initial water-body map 210. In one example, the water-body classifier 204 may create one or more normalized difference water index images (NDWI image 206) from the imagery 202. The water-body classifier 204 may perform global segmentation upon the NDWI image 206 to segment water-body features from non-water-body features by comparing normalized difference values of pixels within the NDWI image 206 to a global threshold (e.g., pixels with normalized difference values above 0.5 may be segmented as water-body features). The water-body classifier 204 may perform one or more localized segmentations upon regions (e.g., pixels corresponding to water-bodies identified by global segmentation) of the NDWI image 206. For example, a first set of pixels may be segmented as water-body features (e.g., based upon global segmentation). Normalized difference values of the first set of pixels and/or other pixels (e.g., neighboring pixels within a threshold distance of the first set of pixels) may be compared against a local threshold to further refine a water-body identified by such pixels (e.g., new pixels may be added to the water-body, pixels may be removed from the water-body, and/or pixels may remain as the water-body). In this way, the initial water-body map 210 may be created.

A digital surface model (DSM) 226 may be used to create a shadow mask image and/or an elevation mask image (e.g., mask images 214) from the imagery 202. It may be appreciated that the DSM 226 may be derived from a stereo matching component 212 and/or other components (e.g., external to the stereo matching component 212). The shadow mask image may comprise one or more shadow features identified from the imagery 202, and the elevation mask image may comprise one or more elevation features identified from the imagery 202. The water-body classifier 204 may be configured to remove 216 portions of the initial water-body map 210 that overlap shadow features and/or elevation features within the mask images 214. In this way, the initial water-body map may be refined at 218 based upon based upon shadow features and/or elevation features.

The DSM 226 may be used to estimate elevations for pixels (e.g., points) within the imagery 202. For example, a stereographical mapping technique may be used to project a point within a first remotely sensed image to a first location, to project the point within a second remotely sensed image to a second location, and to triangulate the first location and the second location to obtain an elevation of the point. A confidence score 220 may, for example, be assigned to the imagery based upon a confidence that the confidence model 212 produced a correct match for a point within a first image of the imagery 202 and the point within a second image of the imagery 202 (e.g., the stereo matching component 212 may generate a confidence that a projection of the point within the first image at a first location corresponds to a projection of the point within the second image at a second location). In one example of a confidence score, a digital surface model confidence score may be assigned to the elevation estimated for the point, which may correspond to a confidence that the DSM 226 produced a correct elevation for the point.

The water-body classifier 204 may be configured to refine 222 spatial extents of water-bodies within the initial water-body map 218 based upon confidence scores, such as confidence score 220, to create a final water-body map 224. In one example, a first pixel within the initial water-body map 218 (e.g., segmented as non-water by initial segmentation 208 due to a green tint of the water from algae) may be determined as corresponding to water based upon the first pixel being assigned a confidence score below a threshold. In another example, a second pixel within the initial water-body map 218 (e.g., segmented as water by initial segmentation 208) may be determined as not corresponding to water based upon the second pixel being assigned a confidence score above the threshold. In another example, a third pixel may retain an initial segmentation based upon a confidence score of the third pixel indicating that the initial segmentation is correct. In this way, the final water-body map 224 may be created. The final water-body map 224 may be utilized by a mapping user interface 226 to define one or more water-bodies within a map.

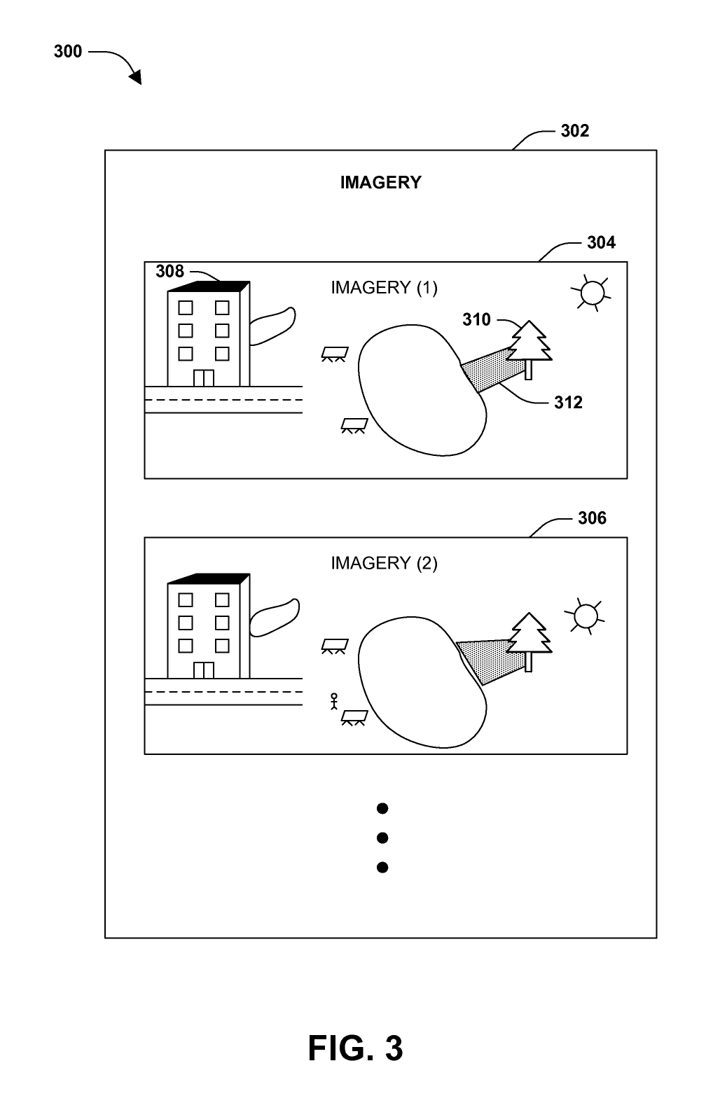

FIG. 3 illustrates an example 300 of imagery 302. In one example, the imagery 302 may comprise one or more images (e.g., multispectral images, panchromatic images, photographs, and/or other image types). For example, the imagery 302 may comprise first imagery 304 (e.g., a first image depicting a scene comprising a building, a building rooftop 308, a tree 310, a tree shadow 312, a lake, a road, picnic tables, etc.), second imagery 306 (e.g., a second image depicting the scene at a different time), and/or other multispectral or other types of images not illustrated. In one example where the imagery 302 comprises a multispectral image, the multispectral image may comprise multiple bands, such as a red band, a green band, a blue band, an infrared band, etc., which may be used to create an normalized difference water index (NDWI) image. For example, a derivative of blue wavelengths and the infrared wavelengths may be used to create the NDWI image. The NDWI image may be used for initial water-body segmentation to create an initial water-body map.

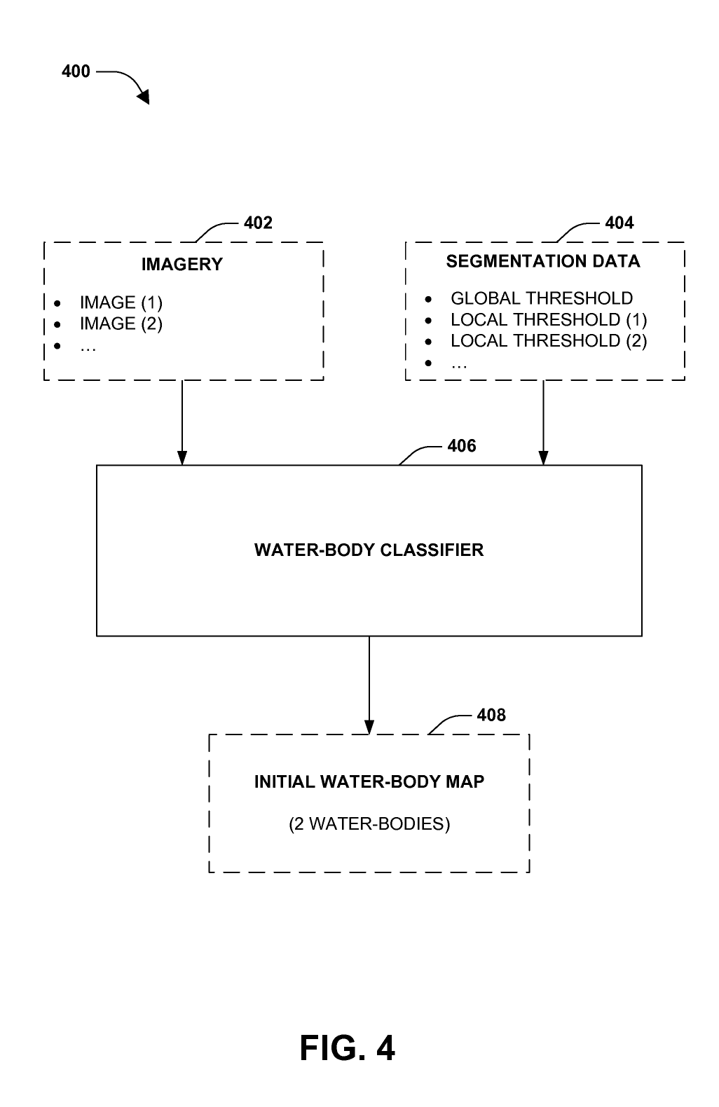

FIG. 4 illustrates an example 400 of creating an initial water-body map 408. A water-body classifier 406 may be configured to perform initial water-body segmentation upon imagery to create the initial water-body map 408. For example, the water-body classifier 406 may utilize segmentation data 404 to segment imagery 402, such as multispectral imagery, for example, into water-body features and/or non-water-body features. In one example, the water-body classifier 406 may create a normalized difference water index (NDWI) image from the imagery 402. The water-body classifier 406 may perform global segmentation by comparing normalized difference values of respective pixels of the NDWI image against a global threshold specified by the segmentation data 404 to segment the NDWI image into water-body features and/or non-water-body features. In another example, the water-body classifier 406 may perform one or more localized segmentations upon regions within the NDWI image (e.g., a first region corresponding to a first water-body, identified by global segmentation, may be evaluated based upon a first local threshold; a second region corresponding to a second water-body, identified by global segmentation, may be evaluated based upon a second local threshold; etc.). In this way, the water-body classifier 406 may create the initial water-body map 408.

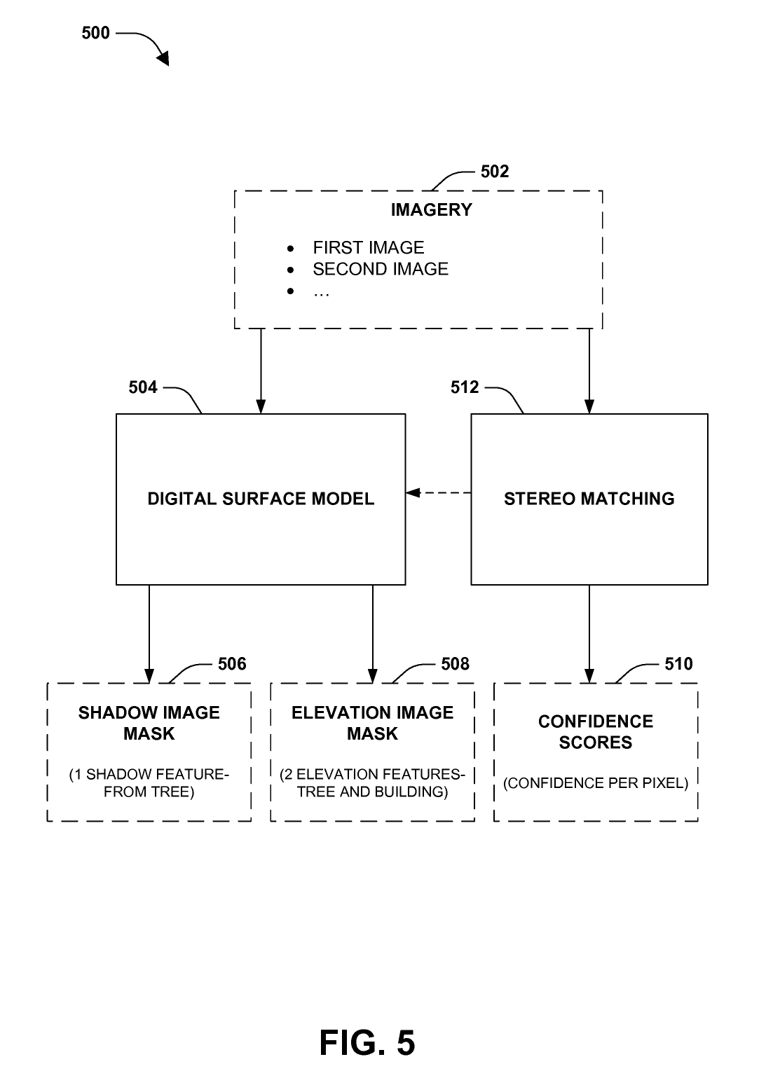

FIG. 5 illustrates an example 500 of a shadow image mask 506, an elevation image mask 508, and/or confidence scores 510. A digital surface model 504 may be configured to process imagery 502 (e.g., utilizing a stereographical mapping technique). In one example, the digital surface model 504 may create the shadow image mask 506 comprising spatial extents of shadow features identified within the multispectral imagery 502 (e.g., a tree shadow 312 of FIG. 3). The shadow image mask 506 may be used to remove portions of an initial water-body map that overlap shadow features within the shadow image mask 506, which may mitigate incorrect classification of shadows as water.

In another example, the digital surface stereo matching model 504 may create the elevation image mask 508 comprising elevation features identified within the imagery 502 (e.g., a building rooftop 308, a tree 310, etc.). The elevation image mask 508 may be used to remove portions of the initial water-body map that overlap elevation features within the elevation image mask 508, which may mitigate incorrect classification of elevated features, such as the building rooftop 308, as water. In another example, a stereo matching component 512 may match points within a first image to points within a second image (e.g., and/or other images) to create confidence scores 510. For example, a confidence score may be assigned to a point (e.g., pixel) based upon a confidence that the point within the first image matches the point within the second image (e.g., a confidence that an elevation estimate for the point based upon triangulating the point within the first image and the second image is correct). The confidence scores 510 may be utilized in refining spatial extents of water-bodies within the initial water-body map (e.g., pixels with relatively low confidence scores may be classified as water, while pixels with relatively high confidence scores may not be classified as water). It may be appreciated that while the shadow image mask 506 is illustrated in FIG. 5 as comprising “1 shadow feature-from tree”, that this is merely a non-limiting example and that one or more shadows could be from any number of sources, such as from one or more trees, one or more buildings, one or more elevated features on the ground, etc. Similarly, while the elevation image mask 508 is illustrated in FIG. 5 as comprising “2 elevation features-tree and building”, that this is merely a non-limiting example and that one or more elevation features could be from any number of sources, such as from a mountain top, any feature with a high elevation, etc.

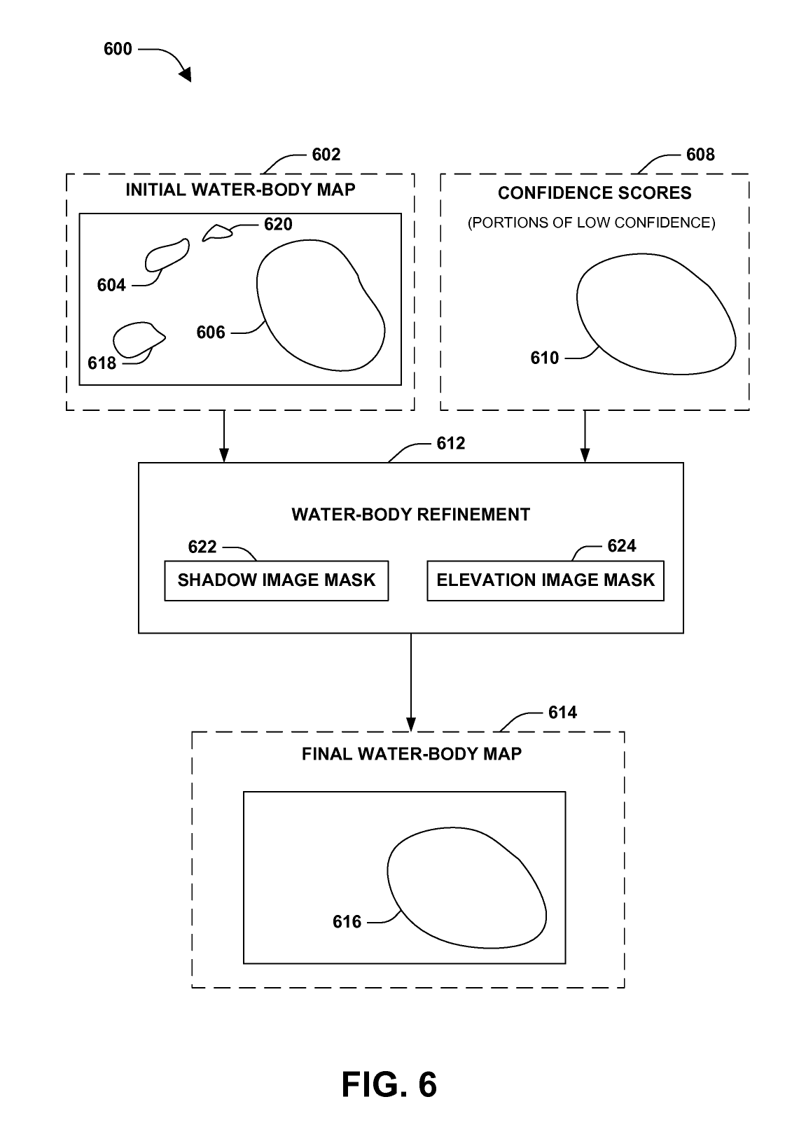

FIG. 6 illustrates an example 600 of creating a final water-body map 614. A water-body refinement component 612 (e.g., comprised within a water-body classifier (e.g., having an in initial water-body map as an input)) may be configured to refine spatial extents of one or more water-bodies within an initial water-body map 602 (e.g., a first water-body 604, and a second water-body 606, a third water-body 618, a fourth water-body 620, etc. may have been identified by initial segmentation of imagery (e.g., water-bodies identified by global segmentation as described with regard to FIG. 4)). The water-body refinement component 612 may utilize confidence scores 608 to refine a spatial extent of the first water-body 604, a spatial extent of the second water-body 606, a spatial extent of the third water-body 618, and/or a spatial extent of the fourth water-body 620. In one example, the confidence scores 608 may comprise relatively low confidence scores for a first portion 610 of imagery (e.g., a confidence model may have a relatively low confidence that estimated elevation for the first portion 610 is correct), and may comprise relatively high confidence scores for other portions of the imagery (e.g., the confidence model may have a relatively high confidence that estimated elevation(s) for the other portions is correct). Because the confidence model may have difficultly estimating elevation of water (e.g., due to non-uniform texture, water movement, white caps, sun reflection, and/or other properties of water), a relatively low confidence score for a pixel may indicate that the pixel corresponds to water. It may be appreciated that the confidence scores 608 are not limited to a confidence that a correct elevation was estimated for a point between two or more images, but that the confidence scores 608 may relate generally to a confidences that points within a first image match points within a second image. Accordingly, confidence score and/or the like as used herein are not intended to be interpreted in a limiting manner, such as to limit the scope of the appended claims, for example, to merely the examples provided herein. In this way, the water-body refinement component 612 may utilize the confidence scores 608 to refine spatial extents of the first water-body 604 and/or the second water-body 606 within the initial water-body map 602 to create the final water-body map 614 comprising a refined water-body 616.

In one example of creating the final water-body map 614, the water-body refinement component 612 may remove (e.g., classify as a non-water-body feature) the first water-body 604, the second water-body 606, and/or the third water-body 618 because pixels corresponding to such water-bodies may be associated with relatively high confidence scores (e.g., the first water-body 604 may actually correspond to a portion of a parking lot as opposed to a water-body feature as identified by initial segmentation, the third water-body 618 may be a shadow that was incorrectly classified as water, the fourth water-body 620 may be an area that was incorrectly classified as water; etc.). For example, the water-body refinement component 612 may utilize a shadow image mask 622 (e.g., to identify the third water-body 618 as corresponding to a shadow) and/or an elevation image mask 624. A spatial extent of the second water-body 606 may be refined to create the refined water-body 616 based upon the first portion 610 being associated with relatively low confidence scores. In this way, the final water-body map 614 may be created.

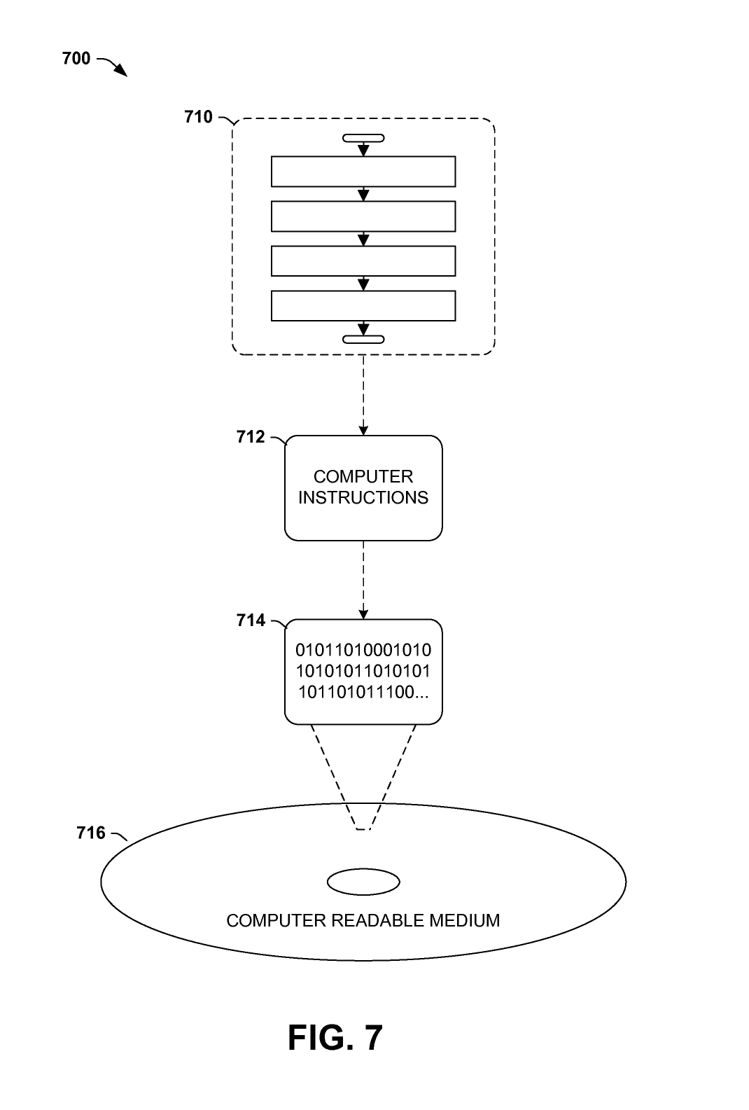

Still another embodiment involves a computer-readable medium comprising processor-executable instructions configured to implement one or more of the techniques presented herein. An exemplary computer-readable medium that may be devised in these ways is illustrated in FIG. 7, wherein the implementation 700 comprises a computer-readable medium 716 (e.g., a CD-R, DVD-R, or a platter of a hard disk drive), on which is encoded computer-readable data 714. This computer-readable data 714 in turn comprises a set of computer instructions 712 configured to operate according to one or more of the principles set forth herein. In one such embodiment 700, the processor-executable computer instructions 712 may be configured to perform a method 710, such as at least some of the exemplary method 100 of FIG. 1, for example. In another such embodiment, the processor-executable instructions 712 may be configured to implement a system, such as, at least some of the exemplary system 200 of FIG. 2, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

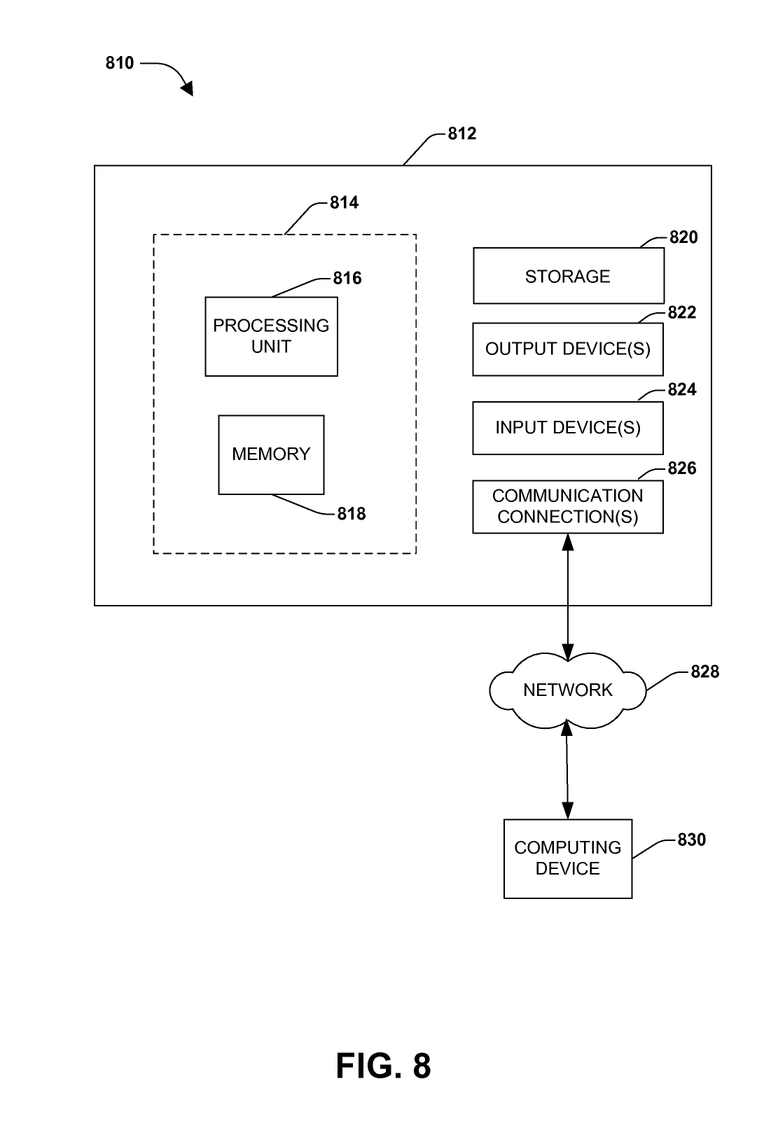

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 810 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 13104), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via a network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for classifying a water-body, comprising:
performing initial water-body segmentation upon imagery to create an initial water-body map; and
refining a spatial extent of a water-body within the initial water-body map based upon a confidence score to create a final water-body map, the confidence score derived from stereo-matching performed on at least some of the imagery.

2. The method of claim 1, the performing initial water-body segmentation comprising:
deriving a normalized difference water index (NDWI) image from the imagery; and
segmenting the NDWI image into water-body features and non-water-body features to create the initial water-body map.

3. The method of claim 2, the segmenting the NDWI image comprising:
comparing respective pixels of the NDWI image against a global threshold to perform global segmentation.

4. The method of claim 2, the segmenting the NDWI image comprising:
comparing respective pixels associated with the water-body against a local threshold to perform localized segmentation.

5. The method of claim 1, the performing initial water-body segmentation comprising:
utilizing a digital surface model to identify spatial extent of shadow features within the remotely sensed imagery to create a shadow mask image; and
removing one or more portions of the initial water-body map that intersect shadow features within the shadow mask image.

6. The method of claim 2, the performing initial water-body segmentation comprising:
utilizing a digital surface model to identify elevation features with elevations above a ground feature threshold to create an elevation mask image; and
removing one or more portions of the initial water-body map that intersect elevation features within the elevation mask image.

7. The method of claim 1, the performing initial water-body segmentation comprising:
removing one or more portions of the initial water-body map that intersect with at least one of:
an elevation feature within an elevation mask image; or
a shadow feature within a shadow mask image.

8. The method of claim 1, the refining a spatial extent of a water-body comprising:
extending the spatial extent of the water-body to comprise one or more neighboring pixels having a confidence score below a threshold.

9. The method of claim 1, the refining a spatial extent of a water-body comprising:
refining the spatial extent of the water-body to not comprise one or more pixels having a confidence score above a threshold.

10. The method of claim 1, the confidence score corresponding to a confidence that a confidence model identified a match of a point amongst two or more images within the imagery.

11. The method of claim 1, the refining comprising:
projecting the point within a first image to a first location;
projecting the point within a second image to a second location; and
triangulating the first location and the second location to obtain an elevation of the point.

12. The method of claim 11, comprising:
assigning a confidence score to the elevation of the point based upon a matching score between one or more features of the first location and one or more features of the second location.

13. The method of claim 12, a feature corresponding to a texture.

14. The method of claim 1, the refining a spatial extent comprising:
determining that a pixel within the initial water-body map corresponds to water based upon the pixel being assigned a confidence score below a threshold, otherwise determining that the pixel does not correspond to water; and
refining the initial water-body map based upon the determination.

15. The method of claim 1, comprising:
utilizing the final water-body map within a mapping user interface to define the water-body within a map.

16. A system for classifying a water-body, comprising:
a water-body classifier configured to:
perform initial water-body segmentation upon imagery to create an initial water-body map; and
refine a spatial extent of a water-body within the initial water-body map based upon a confidence score to create a final water-body map, the confidence score derived from stereo-matching performed on at least some of the imagery.

17. The system of claim 16, the water-body classifier configured to:
determine that a pixel within the initial water-body map corresponds to water based upon the pixel being assigned a confidence score below a threshold, otherwise determining that the pixel does not correspond to water; and
refine the initial water-body map based upon the determination.

18. The system of claim 16, the water-body classifier configured to:
remove one or more portions of the initial water-body map that intersect with at least one of:
an elevation feature within an elevation mask image; or
a shadow feature within a shadow mask image.

19. The system of claim 16, comprising:
a mapping user interface configured to:
utilize the final water-body map to define the water-body within a map.

20. A computer-readable medium comprising processor-executable instructions that when executed perform a method for classifying a water-body, comprising:
performing initial water-body segmentation upon imagery to create an initial water-body map; and
refining a spatial extent of a water-body within the initial water-body map based upon a confidence score to create a final water-body map, the confidence score derived from stereo-matching performed on at least some of the imagery.
